(19) United States
(12) Patent Application Publication
(10) Pub. No.: US 2010/0013639 A1
(43) Pub. Date: Jan. 21, 2010

(54) LOW POWER ASSET POSITION TRACKING SYSTEM

(76) Inventor: Rene Revert, Boynton Beach, FL (US)

Correspondence Address: EDWARDS ANGELL PALMER & DODGE LLP, P.O. BOX 55874, BOSTON, MA, 02205, US

(21) Appl. No.: 12/505,995

(22) Filed: Jul. 20, 2009

Related U.S. Application Data
(60) Provisional application No. 61/135,478, filed on Jul. 21, 2008.

(51) Int. Cl. G08B 13/22; G06K 7/00

(52) U.S. Cl. 340/572.1; 340/10.1

(57) ABSTRACT

A low power asset tracking system includes a mobile unit and a base unit, at least one mobile unit being in communication with the base unit. The mobile unit includes a broadcast circuit having a motion sensor for determining motion of the mobile unit in at least one direction and a transceiver for receiving the motion information signal as a function of an output of the motion sensor. A power source powers the mobile unit. An energizing circuit is disposed between the power source and the transceiver for selectively powering the transceiver. The energizing circuit is under the control of the motion sensor to power the transceiver in response to an output of an energizing signal of the motion sensor. The motion sensor outputs the energizing signal upon detection of a motion in at least one direction of the mobile unit in excess of a threshold amount. The system also includes a base station for receiving the motion information and determining a position of the asset as a function of the motion information.

### CROSS-REFERENCE TO RELATED APPLICATIONS

This application claims priority to U.S. Provisional application No. 61/135,478 filed Jul. 21, 2008 in its entirety.

### BACKGROUND OF THE INVENTION

The present invention is directed to a system which provides asset tracking of a mobile asset, and more particularly a system making use of an asset borne motion sensor.

In modern society, equipment used in everyday lives in hospital environments, business environments, in the field, or in warehouses is designed to be smaller, more mobile, and multi-tasking. The era of dedicated machinery in a dedicated position within a facility is over. Because of that, it has become necessary to track the location of an asset within a facility so that it can be readily accessed when needed. To a lesser extent, the same is true of inventory within a warehouse. Warehouses are designed to rearrange stock in accordance with space availability and inventory amount so that the same type of product may not always be located in the same location within the warehouse from week to week or month to month.

As can be seen asset management is a major concern for companies, corporations, institutions, hospitals, libraries, individuals, and the like. As organizations grow and the assets increase both in number and value, and for individuals as assets increase in value, the importance of managing the location of the assets become critical. As an example in the hospital environment knowing the location of a high-demand asset such as the closest defibrillator could be crucial in a life support situation. For corporations knowing the locations of the assets would enable them to more effectively utilize the asset and reduce operating costs by not having to over-allocate funding for additional assets. For individuals, the location of a high-demand asset such as a laptop computer can prove to be essential. As an example it has been recently reported (PCWorld Jun. 30, 2008) that over 10,000 laptop computers are misplaced every week in United States airports. It would prove to be extremely valuable to determine when the asset has moved or is moving out of a predetermined perimeter region surrounding the individual.

Current asset management techniques vary in complexity and their use of technology. The approaches vary from manual techniques involving individuals searching areas and manually noting the location of the asset to RFID tagging. The manual technique is highly time consuming, cost intensive, and prone to error. Legacy technologies can involve the use of RFID (Radio Frequency Identification) tags to locate assets, but this approach requires a large investment in an infrastructure that is capable of interrogating the RFID tag when the asset is in close proximity to the interrogation equipment.

This solution has proven satisfactory. However, this prior art solution requires constant periodic polling of the asset and a reply even if the asset has not changed status. The reply requires energy provided by a battery. The battery must be sufficiently large to avoid constant replacement, which uses up real estate on the RFID tag, or make the tag too large to be used on smaller assets like a monitor.

A company by the name of RadarFind has attempted to solve the problem of battery life for tracking assets in a hospital environment. RadarFind utilizes a battery-powered RF asset tag that is mounted to the assets within the hospital. To attempt to extend battery life in the asset tags RadarFind utilizes an approach whereby the asset tag resides in a dormant state consuming low levels of current and periodically awakens, consumes additional current and listens for a transmission from a central unit. During this interval if the central unit transmits a request, the asset tag responds by transmitting information to the central unit. From that transmission the central unit estimates the location of the asset tag. If the central unit does not transmit while the asset tag is awake, the asset tag returns to the dormant state. The asset tag in the RadarFind system attempts to extend the battery life by reducing the duty cycle, or reducing the ratio of the amount of time that the asset tag is awake versus the amount of time the asset tag is in the dormant state.

The major shortcoming of the RadarFind implementation is that there can be significant delays in location update estimates to the central unit for the actual location of the asset. However, increasing the accuracy of the location update estimate by interrogating the asset frequently reduces the battery life.

What is desired is an asset tracking device that overcomes these shortcomings through the use of motion sensors, to both increase the accuracy of the location estimate and increase the battery life.

### BRIEF SUMMARY OF THE INVENTION

The asset tracking system of the present invention is composed of two embodiments with either two or three major subsystems. The embodiment with three major subsystems contains a mobile unit subsystem to be associated with the asset, The mobile unit subsystem contains a broadcast circuit. A base subsystem remote from the mobile unit contains a detection circuit, in communication with the broadcast circuit. A server subsystem communicates with the base subsystem.

The embodiment with two major subsystems contains the mobile unit subsystem containing a broadcast circuit and the base subsystem containing a detection circuit. The base system may also contain an audio-visual alert circuit.

In either embodiment the broadcast circuit is mobile and resides on the asset. To enable mobility, the broadcast circuit contains an internal power source such as a battery and a motion sensor. The broadcast circuit remains in a quiescent mode of operation with the majority of the remainder of circuit inactive, thereby minimizing power consumption. When the mobile device experiences motion displacement beyond a predetermined value the broadcast circuit exits the quiescent mode, enters the active mode, powers on and generates an information transmission. The detection subsystem receives the transmission and by fusing transmitted motion sensor information and the received signal properties, resolves the location of the mobile device.

### BRIEF DESCRIPTION OF THE DRAWINGS

Other objects, features, and advantages of the present invention will be apparent from the written description and the drawings in which:

FIG. 1 is a block diagram of a mobile unit including a broadcast circuit constructed in accordance with the invention.

FIG. 2 is a block diagram of another embodiment of a mobile unit having audio and audio visual indicators constructed in accordance with the invention;

FIG. 3 is a block diagram of a base unit having a detection circuit and a server interface constructed in accordance with the invention;

FIG. 4 is a block diagram of a base unit having a detection circuit and audio visual indicators constructed in accordance with the invention;

FIG. 5 is a block diagram of the server subsystem and interfaces associated with the server subsystem constructed in accordance with the invention;

FIG. 6 is a block diagram of one embodiment of the asset tracking system constructed in accordance with the invention;

FIG. 7 is a block diagram of another embodiment of the asset tracking system constructed in accordance with the invention;

FIG. 8 is a block diagram of yet another embodiment of the asset tracking system constructed in accordance with the invention;

FIG. 9 is a block diagram of still another embodiment of the asset tracking system constructed in accordance with the invention;

FIGS. 10 and 11 are flow charts showing operation of the mobile unit in accordance with the invention;

FIG. 12 is a flow chart showing the operation of a timer circuit by the mobile unit in accordance with the invention;

FIGS. 13 and 14 are flow charts showing operation of the base unit in accordance with the invention; and

FIGS. 15 and 16 are flow charts showing operation of a server in accordance with another embodiment of the invention.

### DETAILED DESCRIPTION OF THE PREFERRED EMBODIMENT

The fundamental operation of the asset tracking system in accordance with the invention utilizes specific properties associated with motion, primarily acceleration and velocity in at least one of three axes. It is known that unless an asset never moves or maintains a constant speed and direction forever, the asset exhibits a positive acceleration, a velocity and a negative acceleration (deceleration) during travel. As a result these values may be used to compute the displacement and final location of an asset.

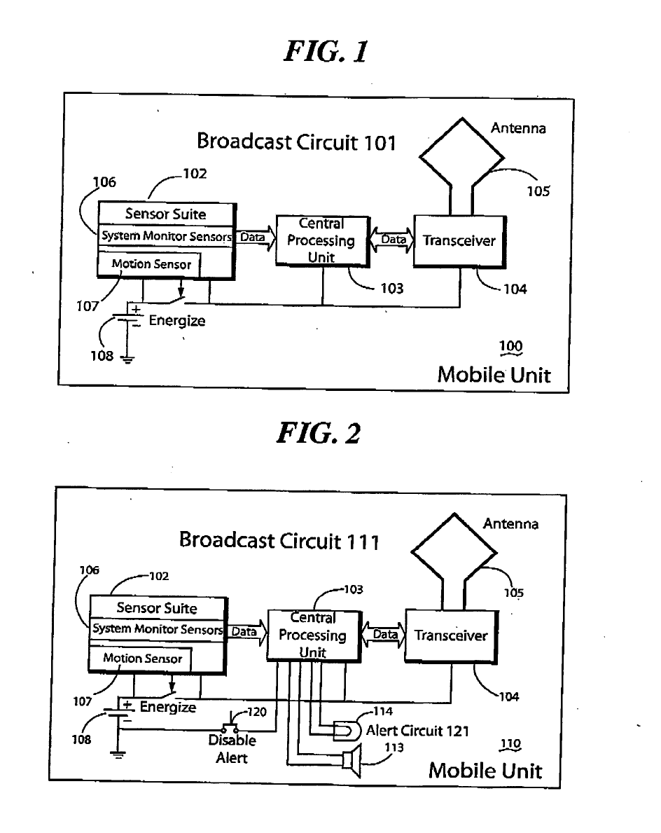

Reference is first made to FIG. 1 wherein a mobile unit 100 constructed in accordance with the invention for attachment to mobile asset to be monitored is shown. Mobile unit 100 includes a broadcast unit 101. Broadcast circuit 101 includes a sensor suite 102 including system monitors sensors 106 and motion sensor 107. Sensor suite has a motion sensor 107 consist of accelerometers, gyroscopes. System monitor sensor 106 may include temperature sensor and timing circuitry. The accelerometers and gyroscopes can be used singly or in concert to provide measurements of acceleration in from one to three orthogonal axes. The measurements will be made over time and will be utilized to provide accurate position and velocity estimates for the broadcast circuit 110. The temperature sensor provides ambient temperature measurements over time to enable compensation for temperature-related drift characteristics of the accelerometers and gyroscopes.

Sensors 106 and 107 are powered by a battery 109 through an energizer switch 108. Each of sensors 106 and 107 provides a data output to a Central Processing Unit (CPU) 103, also powered by battery 109 through energizing circuit 108. CPU 103 processes the sensor data and stores the data in a local memory (not shown) which may be internal of the CPU 103 or, an onboard database. CPU 103 provides a data output as a motion information signal corresponding to the motion sensed by motion sensor 107 to a transceiver 104 which broadcasts the data through a multi element antenna 105. Transceiver 104 is also capable of receiving data as discussed below.

Motion sensor 107 senses motion of mobile unit 100, which directly corresponds to the motion of an asset to which mobile unit 100 is affixed. Once an asset is in motion, motion sensor 107 determines whether the amount of motion exceeds a predetermined threshold. When a determination is made that the threshold has been exceeded, motion sensor 107 exits the quiescent state by outputting an energizing signal to energizing circuit 108, to close a power circuit such that power source 109 powers the remaining circuitry of broadcast circuit 101. Motion sensor 107 provides an output to CPU 103 of one or more of direction, speed, acceleration, velocity and duration. CPU 103 provides a combination of one or more of these values to transceiver 104 for transmission.

In a preferred, but non-limiting embodiment, motion sensor 107 is an accelerometer capable of determining acceleration as an amount and a direction along at least 2 axes. However, motion sensor 107 may be a gyroscope. Energy source 109 may be a conventional battery, a rechargeable battery, a solar photovoltaic cell, or any other power source which lends itself to use in a portable device. Mobile unit 100 may be a circuit affixed to an asset, or may be the asset itself such as a mobile phone, laptop computer, or the like in which broadcast circuit 101 is integrally formed with the asset.

Reference is now made to FIG. 2 in which a block diagram of a mobile unit 110 having a broadcast unit 111 constructed in accordance with a second embodiment of the invention is provided. Like numerals are utilized to indicate like structure. The primary difference between broadcast circuit 111 and broadcast circuit 101 is the inclusion of alert circuitry 121 as part of broadcast circuit 111.

CPU 103 provides outputs to an alert circuit 121 having a speaker 113 for audio alarms and a lamp 114 for visual alarms. Lamp 114 may be an ordinary incandescent light bulb, LED, or even a message board capable of producing word or image messages at a display. CPU 103 controls alert circuit 121 in response to a disable alert switch 120 disposed between power source 109 and CPU 103. Again, motion sensor circuit 107 exits the quiescent state when the motion of the asset exceeds a predetermined threshold. When the motion event occurs the motion sensor powers additional circuitry with the battery 109 and the energizing circuit 108. These circuits include the CPU 103, the RF transceiver 104 and the audible and visible alert circuit 121. The audible and visible alert circuit 121 is controlled by a disable circuit 120 that de-energizes the audible and visible alert circuit 121. The RF transceiver 104 transmits and receives Radio Frequency (RF) energy through the antenna 105.

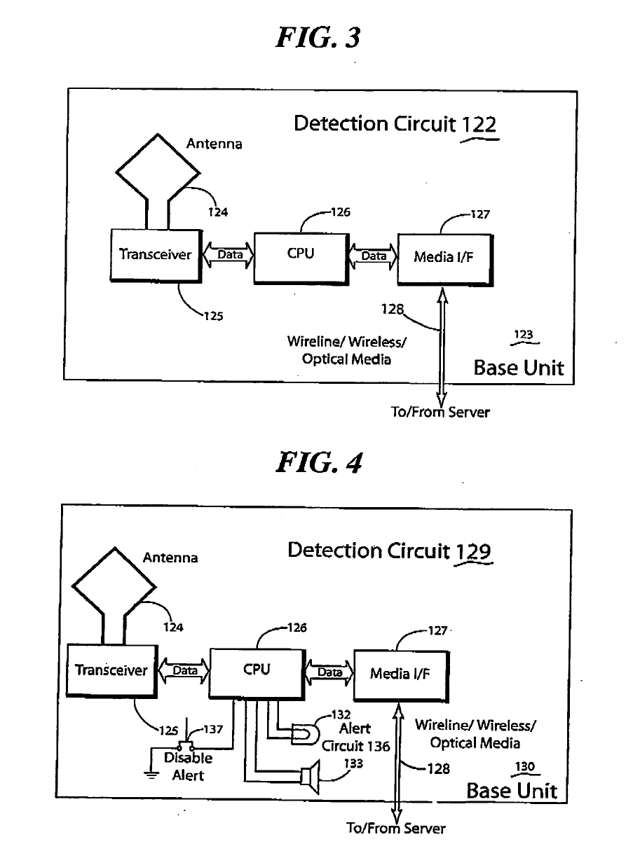

Reference is now made to FIG. 3 in which a block diagram of a base unit 123 having detection circuit 122 constructed in accordance with the invention is provided. Detection circuit 123 monitors the incoming transmissions from a broadcast circuit 101, 111 in the mobile devices 100, 110. Detection circuit 122 includes a transceiver 125 and a CPU 126. CPU 126 receives and transmits data from broadcast circuit 101 through a transceiver 125 and an associated multi-element antenna 124. CPU 126 also receives data from and provides data to a media interface 127. Media interface 127 communicates with a server 138 by a communication link 128. Communication link 128 may be hardwired by a wire or other affixed communication medium or may be wirelessly connected to server 138 by way of cellular communication, radio frequency communication or the like.

The receiver circuit contained in the transceiver 125 circuit, using multi-element antenna circuit 124, monitors for mobile unit 100, 110 transmissions and inputs any received data to CPU 126. CPU 126 reviews the content of the message and directs the transmitter circuit in transceiver circuit 125 to send an acknowledgement signal to the broadcast unit through multi-element antenna 124. CPU 126 subsequently transmits the received information from mobile units 100, 110 to a server subsystem over communication link 128 using the media interface circuit 127.

Reference is now made to FIG. 4 in which a block diagram of a base unit 130 having a detection circuit 129 constructed in accordance with another embodiment of the invention is provided. Like elements are indicated by like numbers for ease of description. The primary difference being the inclusion of an alert circuit 136 in detection circuit 129. The receiver circuit contained in transceiver 125, using a multi-element antenna circuit 124, monitors for transmissions from mobile units 100, 110 and provides the data to CPU circuit 126. CPU circuit 126 reviews the content of the message from mobile unit 100, 110 and directs the transmitter circuit in transceiver 125 to send an acknowledgement signal to broadcast circuit 101, 111 through multi-element antenna circuit 124. CPU 126 subsequently transmits the received information from broadcast circuit 101, 111 to the server subsystem 138 over communication link 128 using the media interface circuit 127.

Audio visual alert circuit 136 is provided under the control of CPU 126. In a preferred embodiment alert circuit 136 includes an audio alert 133 and a visual alert 132. The visual alert 132 may take the form of an incandescent bulb, LED, LCD display or a messaging display, or the like as known in the art. Similarly, audio alert 133 may take the form of a speaker or any other form of noise maker. A disable alert switch 137 provides an input to CPU 126 to allow discontinuation of the alarm.

The motion sensor information consists of acceleration from one to three orthogonal axes and/or rotational displacement in from one to three orthogonal axes. The information contained in the received signal properties consist of the amplitude of the received signal, and the angular phase variations of the signal over time as the broadcast circuit experiences the motion imparted by the asset. The motion sensor and received signal information is coupled together utilizing sensor fusion algorithms implemented as a discrete-time Kalman filter to provide accurate position and velocity estimates of the broadcast circuit. The Kalman filter utilizes a mathematical description of the states to be estimated of the dynamic system consisting of the motion of the broadcast circuit. The equations describe how the mean of the state and the covariance of the state propagate with time. The a priori state estimates can be computed from the previous time step and the current measurement of accelerations and received signal properties. These a priori state estimates are utilized to recursively update the Kalman filter gain using a matrix Ricatti equation. The Kalman filter output provides the a posteriori estimates for position and velocity from combining the current state with the product of the Kalman filter gain and the acceleration measurements and the received signal properties. As a result, the change in motion is used by a detection CPU in a detection circuit, or a server to determine the new position of the mobile unit 100 and the associated asset.

The motion sensor suite 102 contains internal threshold registers for each orthogonal direction axis that can be programmed by CPU 103 for low and/or high threshold values. Excursions into the areas that are delineated by the thresholds are then measured with respect to time. There now exists two degrees of freedom that can be thresholded to determine if the asset has experienced a motion alert threshold. The two degrees of freedom are the amount that the thresholds have been exceeded, and the duration of the excursion. These two variables have thresholds applied to them to determine if this motion is sufficient to alert the broadcast circuit and/or enable the alert circuitry

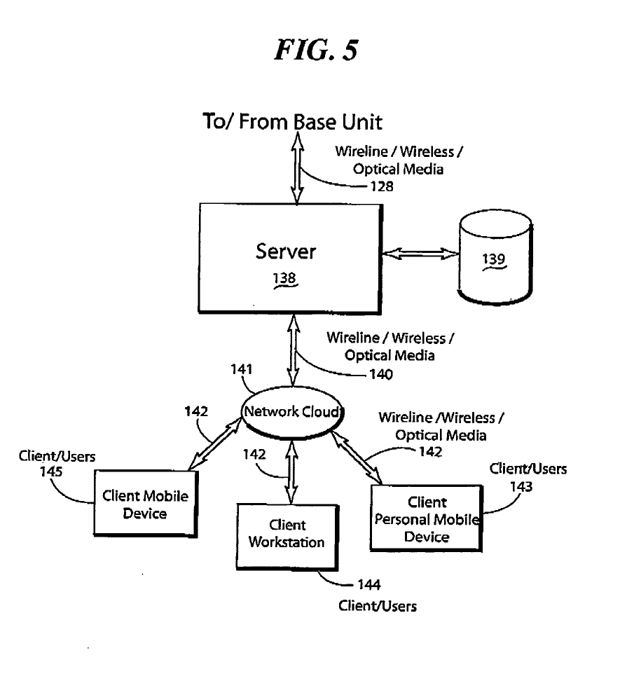

Reference is now made to FIG. 5 in which a block diagram of the server subsystem 138 constructed in accordance with the invention is provided. Server 138 and an associated database 139 maintain the inventory information regarding the current position of each asset being tracked utilizing a base unit 130 and mobile unit 110 by way of example. As data is received from a base unit 130, server 138 compares the new data to location information regarding that particular asset stored in database 139 to determine a new position. Furthermore, as each new bit of detected data received at server 138 corresponds to a new movement and in turn location of mobile unit 110, by storing each data input, a position log/history of each particular asset may be maintained in database 139 for use analysis of an asset.

More specifically, server subsystem 138 receives the location, status, and monitoring information that have been received by detection circuit 129 in the base unit 130 from the broadcast unit 111. This information is utilized to populate and update database 139 of the assets that are being managed for a particular user or group of users 143, 144, 145. The users 143, 144, 145, can securely query the server 138 over a communication link 140 regarding the assets using a network cloud 141, by way of non-limiting example and display the status locally over a graphical user interface such as an Internet web browser window.

In a further embodiment of the invention, server 138 may provide either delayed or real time notification of the movement of an asset to users having an interest in the position of such asset. A movement beyond a threshold amount may trigger server 138 to report an asset position. This changes the system from a conventional pull/poling type system to a push system which makes more efficient use of the energy, computing assets and time.

It should be noted, server 138 was described in connection with motion sensor circuit 111 and detecting circuit 129. However, server 138 operates almost identically when using any permutation of the combination of broadcast circuits and detection circuits described above. Furthermore, the connection 142 from server 138 may be any type of connection either directly hard wired such as by standard copper or other metallic wiring, optical fiber or the like, as well as wirelessly by radio frequency, cellular, internet, cloud or other known technologies or the like.

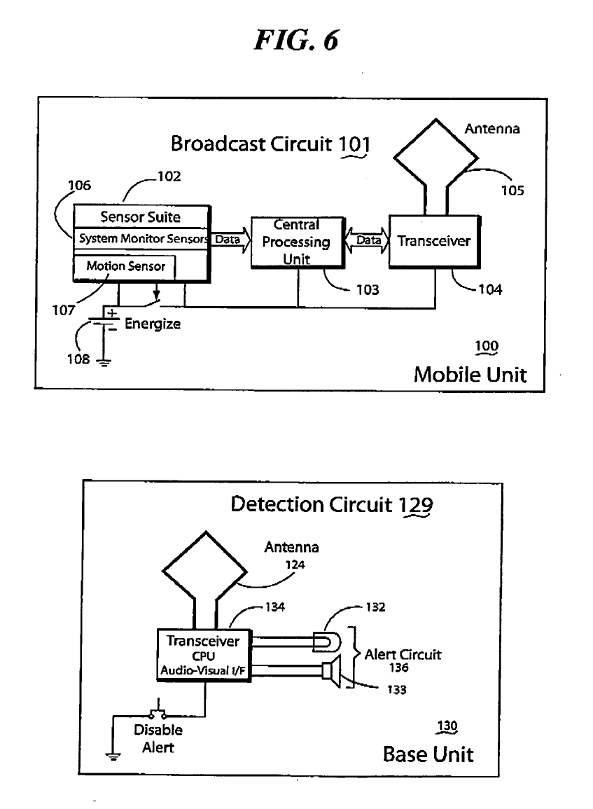

Reference is now made to FIG. 6 in which a block diagram of one embodiment of an asset tracking system generally indicated as 1000, constructed in accordance with the invention is provided. It should be noted that the combinations of system 1000 is, of by way of non-limiting example only, and that each broadcast circuit may operate with each detection circuit described above. Like numerals are used to indicate like structures. System 1000 consists of broadcast circuit 101 residing in a mobile unit 100 capable of communicating with detection circuit 129 containing alert circuit 136 in base unit 130. Here for ease of explanation, transceiver 125, CPU 126, and media interface 127 are combined into a single CPU/transceiver circuit 134 at base station 130.

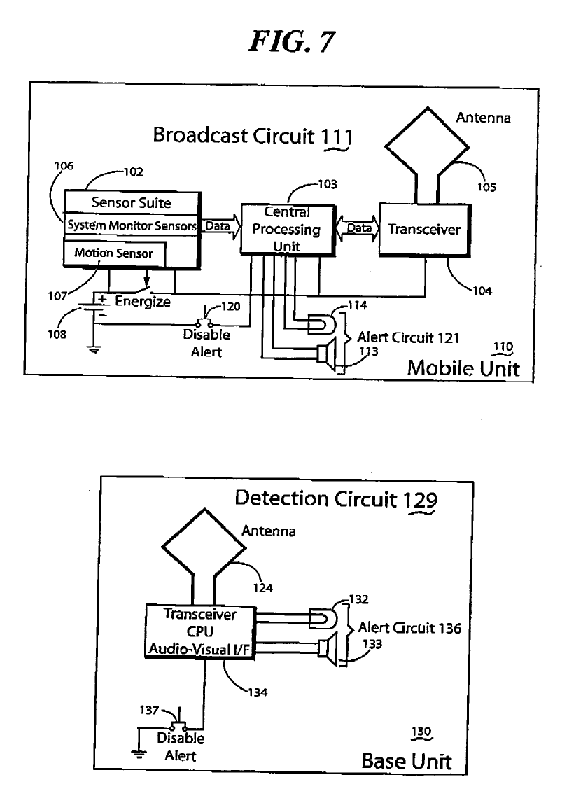

Reference is now made to FIG. 7 in which a block diagram of the asset tracking system, generally indicated as 1200, and constructed in accordance with another embodiment of the invention is provided. For convenience of description, like structure is indicated by like numerals. System 1200 consists of broadcast circuit 111 residing in a mobile unit 110 containing an alert circuit 121 capable of communicating with detection circuit 129 containing alert circuit 136 in base unit 130.

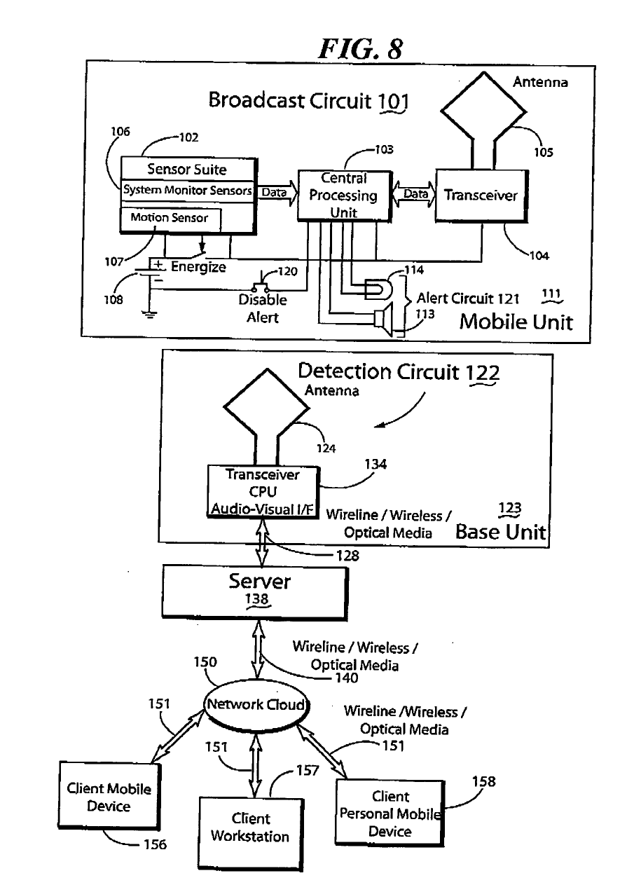

FIG. 8 depicts a block diagram of yet another embodiment of an asset tracking system, generally indicated as 1300, and constructed in accordance with the invention. Again, like numerals are used to indicate like structure. System 1300 consists of a broadcast circuit 101 residing in a mobile unit 111 containing an alert circuit 121. Broadcast circuit 101 communicates with a detection circuit 122 contained in a base unit 123. Detection circuit 122 communicates with a server subsystem 152 through communication link 128.

In this embodiment server 152 is connected to a network cloud 150 over communications link 140. In turn, various client devices communicate with server 152 across communications links 151 and network cloud 150. Such devices may be a client mobile device 156 such as a personal digital assistant, a cellular phone, a pager, or the like. A client workstation 157 making use of a laptop or personal computer may also communicate across the internet utilizing communication link 150. Lastly, a client personal mobile device of any other type 158 may communicate through communication link 151 and network cloud 150 to server 152. In this way, asset management and asset location tracking may be performed across a distributed network. Communication links 151 may be hard wired links such as conventional metallic wire, optical fiber or the like or may be wireless such as a radio frequency communication, a cellular communication or the like.

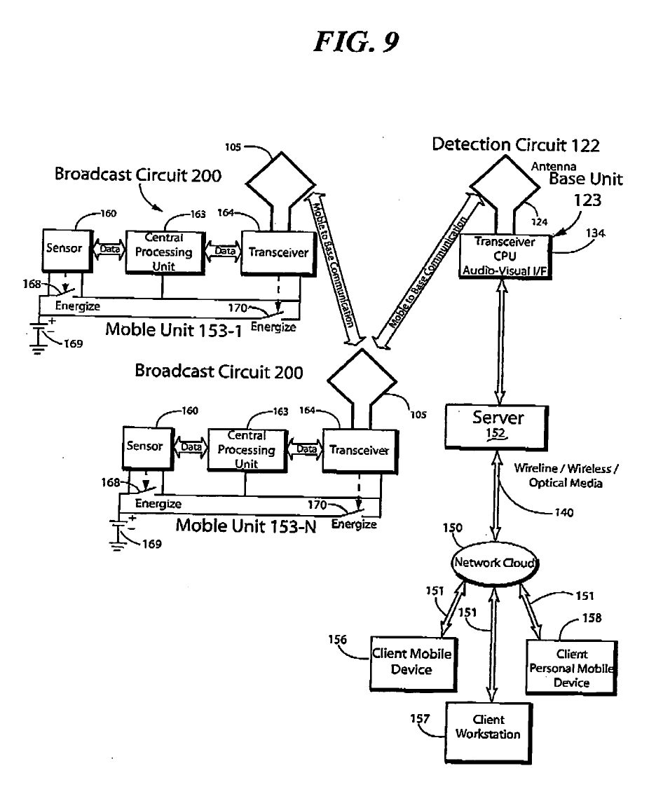

Reference is now made to FIG. 9 in which a system, generally indicated as 1400, constructed in accordance with yet another embodiment of the invention as provided. Like numerals are utilized to indicate like structure. In this embodiment multiple broadcast circuits 200 associated with multiple units 153 1-N report to a single Detection Circuit 122 associated with a base unit 123.

A first broadcast circuit 200 associated with a mobile unit 153-1 includes a sensor 160 which at a minimum senses motion at mobile unit 153-1 and provides a data input to a CPU 163. CPU 163 provides data to a transceiver 164 for transmission by a multi-element antenna 165. Received data from the transceiver 164 is provided to the CPU 163 when communication is received from either another mobile unit 153-N or the Base Unit 123 A power source 169 which may be a battery, solar photovoltaic excel or the like provides power to at least each of the elements of broadcast circuit 200. Power is provided under the control of an energized switch 168 which is controlled by an output from sensor 160. Upon detection of motion which exceeds a predetermined threshold amount, sensor 160 closes energizer switch 168 to power CPU 163 and transceiver 164. A second energizer switch 170 in parallel with energizer switch 168 between power source 169 and the remaining elements of broadcast circuit 200 is operated under the control of transceiver 164

At least a second mobile unit 153 is provided having structure identical to mobile unit 153-1. Mobile units 153 1-N are in communication with each other by way of transceiver circuits 164, 169. As discussed above, base unit 123 is in communication with a server 152 which in turn may be in communication across network cloud 150 with a number of client devices 156, 157, 158. It should be noted, that a single server 152 may also be capable of operation with a plurality of base units 153 1-N (not shown) or that client devices 156, 157, 158 may be in communication with one or more servers 152 1-N. However, to facilitate description, the description of the system is made in terms of two broadcast circuits, one detection circuit, and one server.

It should be noted that when a mobile unit 153 1 is not in range of the base unit 123, its information is transferred from mobile unit 153 1 to mobile unit 153 N−1 until it arrives at a mobile unit 153 N that has established communication with the detection circuit 200 in the base unit 123

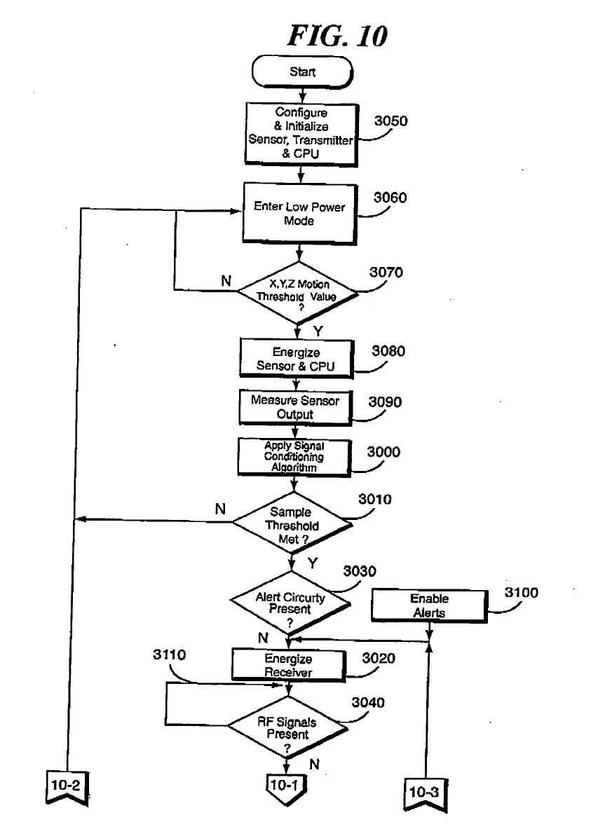

Reference is now made to FIG. 10 in which operation of a broadcast circuit on a mobile unit in accordance with the invention is provided. For ease of description, the operation of broadcast circuit 111 will be described. It follows that the operation of the system utilizing broadcast circuit 101 or a mobile unit 100 may be utilized. It is well understood by those skilled in the art given the teaching of the present invention that operation utilizing a broadcast circuit 101 is similar only done without the circuit alert 121.

The sensors 102, 106, 107, transceiver 104, and the CPU 103 are configured and initialized in a step 3050. Upon completion of the initialization tasks CPU 103 directs all circuitry to enter the low power mode of operation in a step 3060. Asset tracking system 1200 remains in the low power mode until motion of a tracked asset exceeds a threshold value as determined in a step 3070.

This determination is done in at least two and preferably three dimensions. Each dimension may have a different threshold value and different thresholds may exist as a function of motion in two or more dimensions. If the threshold value as sensed by motion sensor 107 is exceeded in a step 3070 asset tracking system 1200 is energized in a step 3080. Motion sensor 107 activates energizer circuit 107 to power up broadcast circuit 111. Once energized sensor 107 outputs are sampled, measured, and quantized in a step 3090. The motion sensor 102 outputs are provided to CPU 103 where they are filtered, conditioned, and specialized algorithms applied in a step 3000 to the measured motion quantities as a function of a combination of one or more of direction, speed, acceleration, velocity and duration. A time stamp is associated with the motion values. These quantities are subsequently stored in the local memory by CPU 103 on board mobile unit 110.

After a group of data samples is collected CPU 103 determines, based on predetermined criteria, in a step 3010 whether to transmit the motion information to base unit 130 and/or activate alert circuitry 121. If the criteria is not met broadcast circuit 111 returns to the low power mode in a step 3060. If the criteria is met in step 3010 CPU 103 circuit enables the transceiver 104 in a step 3020 and tests for the presence of the alert circuitry 121 in a step 3030.

If the alert circuitry 121 is present it is enabled in a step 3100 while transceiver 104 is energized. Transceiver 104 listens in a step 3040 to determine if there is any communication occurring over the Radio Frequency (RF) link with detection circuit 129. If there is no communication broadcast circuit 111 enables transceiver 104 in a step 3051 and transceiver 104 transmits the motion information in a step 3061 to detection circuit 129 in the base unit 130.

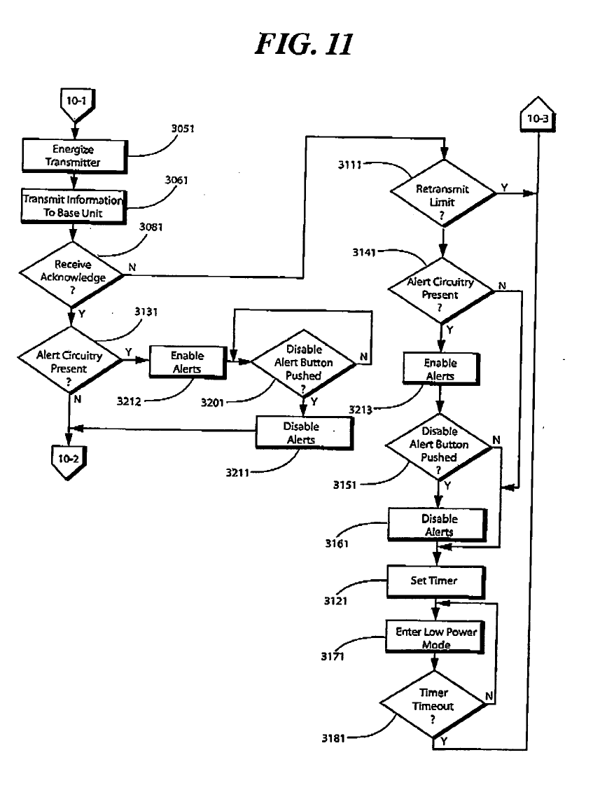

If the transceiver 104 determines that there is communication occurring in a step 3110, broadcast circuit 129 remains in listening mode in a step 3040 listening for any communication, i.e. radio frequency signal is present, occurring over the Radio Frequency (RF) link. This process continues until there is no communication detected over the Radio Frequency (RF) link, at which time broadcast circuit 111 energizes the transceiver 104 in a step 3051 (FIG. 11) and transmits the information to the detection circuit 129 in a step 3061.

After completing the transmission, the receive circuitry in transceiver 104 listens for the response from detection circuit 129 of base unit 130, in a step 3081. The response takes the form of an acknowledgement signal. If an acknowledgement signal is received broadcast circuit 111 determines if the alert circuitry 121 is present in a step 3131. If the alert circuitry is present the alert circuitry is enabled in a step 3212, if the alert circuitry is not present the broadcast circuit 111 returns to low power mode 3060. If it is determined that the disable alert button 120 was pressed in step 3201, alert circuitry 121 is disabled.

If an acknowledgment is not received in step 3081, this process continues for a predetermined number of times as determined by CPU 103 in a step 3111, or until an acknowledgement is received, at which point broadcast circuit 111 returns to the low power mode in step 3020. If there was no acknowledgement of the transmission, retransmissions will continue and the number of retransmissions will be compared to a threshold value in step 3111. If the retransmit threshold has not been exceeded retransmissions will occur as discussed above. If the retransmit threshold is met the broadcast circuit determines if the alert circuitry 121 is present in a step 3141 and disables the alert circuitry 121 in a step 3161 if the alert circuitry is present and if the disable alert button 120 has been activated as determined in a step 3151.

This sequence is followed by the broadcast circuit 111 enabling and setting a periodic timer in a step 3121 and entering a low power mode in a step 3171. The timer will periodically be queried by CPU 103 in a step 3181 to determine if a timeout has occurred for the timer. If the timeout has occurred the retransmit counter is reset in a step 3191, and broadcast circuit 111 exits the low power mode and attempts to retry to complete an acknowledged transmission in a step 3191 and return to step 3100.

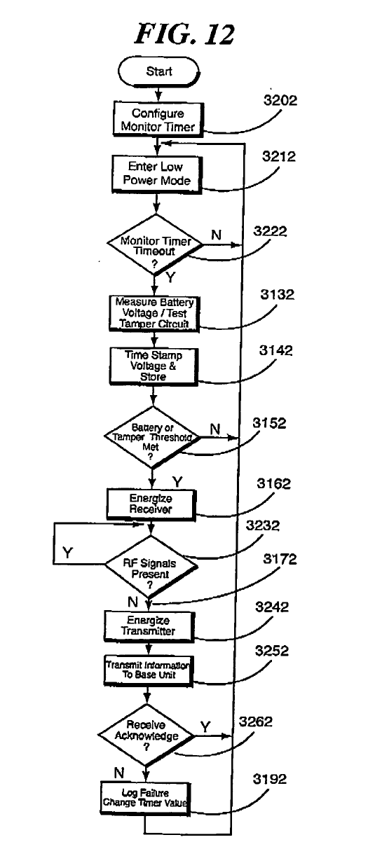

The broadcast circuit 130 additionally implements a timer circuit that periodically determines the status of the broadcast circuit 111 subsystems. During the execution of initialization step 3050 in FIG. 10, the monitor timer initialization beginning with step 3202 in FIG. 12 is also executed configuring the parameters for the monitor timer circuitry. Upon completion of step 3202 a status timer circuit on board mobile unit 110 enters a low power mode 3212.

Periodically, the monitor timer circuit executes a query in a step 3222 to determine whether the timer value equals a terminal count stored in the local database and the associated operations should be executed. If the timer value is less than the terminal count as determined in step 3222 broadcast circuit 111 reenters the low power mode in step 3212. If the timer value equals the terminal count value as determined in step 3222 a broadcast circuit 111 initiates a status update mode in step 3132 by causing CPU 103 to measure the battery voltage and test the tamper circuit. The initial status information extracted is the measurement of the battery level and the status of the tamper circuitry as determined in step 3132 which is subsequently stored and time stamped in local memory in a step 3142. This event might occur once a day and the sampling interval might take 10 msec. This equates to a duty cycle of approximately 0.0000001. Therefore this short duty cycle has an insignificant effect on battery life, and it informs the user of the remaining charge in the battery

The broadcast circuit maintains a predetermined number of measurements in memory with the associated time stamp of the measurements as obtained in step 3142. If the battery level reaches a predetermined threshold or the tamper circuit continuity is interrupted as determined, in a step 3152 broadcast circuit 111 exits a low power mode and the broadcast circuit enables the transceiver 104 in a step 3162 and listens to determine if there is any communication occurring over the Radio Frequency (RF) link in a step 3232.

If there are no Radio Frequency signals present as determined in a step 3172 broadcast circuit 111 enables transceiver in a step 3242 and transmits the information to detection circuit 129 base unit 123 in a step 3252. If there are Radio Frequency signals present, the broadcast circuit returns to a low power mode for a randomly selected time interval in a step 3182, returns to the active state, enables transceiver 104 and listens for any communication occurring over the Radio Frequency (RF) link in a step 3232.

This process continues until there are no Radio Frequency (RF) signals detected over the Radio Frequency (RF) link, at which time broadcast circuit 111 transmits the motion information to detection circuit 129. After completing the transmission, broadcast circuit 111 enters the receive mode and listens for an acknowledgement signal from base unit 130 in a step 3262. If an acknowledgement signal is received the broadcast circuit enters the low-power mode of operation in step 3212. If no acknowledgement signal is received the failure is logged and the broadcast circuit 111 enters the quiescent low-power mode of operation and resets the monitor timer for more frequent timeouts to alert the base unit of the event in a step 3192.

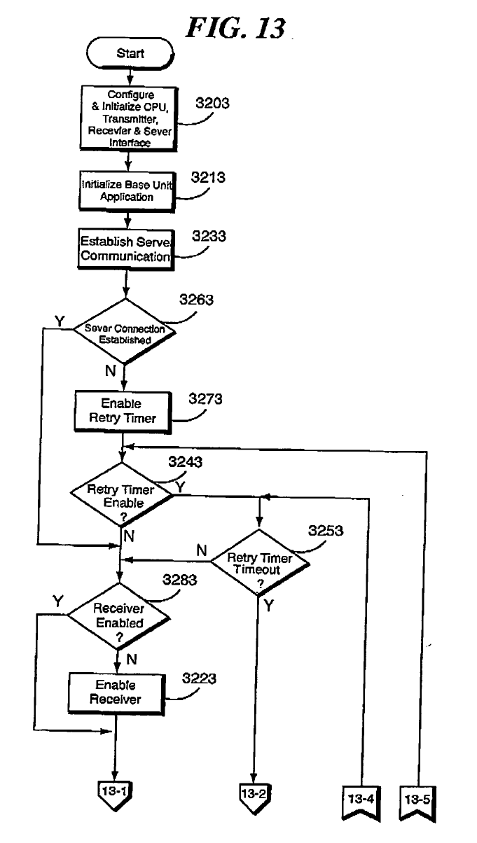

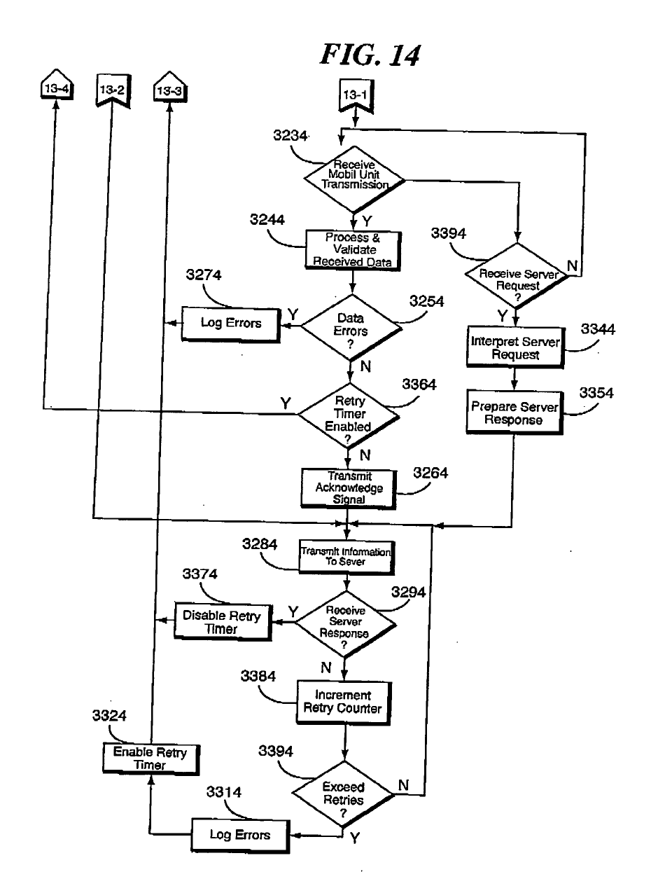

Reference is now made to FIGS. 13 and 14 where a flow chart for server/base station communication in accordance with the invention is provided. Again system 1200 is used by way of non limiting example. Circuit 134 is initialized in a step 3203. Upon completion of the initialization tasks the CPU 134 initializes a base unit application in a step 3213. At the completion of the base unit application the base unit 130 attempts to establish a communication link with a server 138 in a step 3233. The establishment of the server communication link is initiated by enabling a timer that periodically attempts to establish the communication link with the server. If link establishment has not been successful as determined in a step 3263, a retry timer is enabled in a step 3273. A test is subsequently performed in a step a 3243, by base unit 130 to determine if the retry timer is enabled. If the retry timer is not enabled as determined in step 3243 base unit 130 executes a test to determine if the receiver is disabled in a step 3283. Retry timer and other timers may be integrally formed with circuit 134 and/or server 128.

If the receiver is disabled as determined in a step 3283 base unit 130 enables the receiver of circuit 134 in a step 3223 and initiates listening for data transmissions from mobile unit 110 in a step 3234. If the receiver is enabled as determined in step 3283 base unit 130 executes a test to determine if a data transmission has been received from a mobile unit 110 in a step 3234.

If no data transmission is received from a mobile unit 110, as determined in a step 3234 the mobile unit executes a test to determine if server 138 has initiated a request in a step 3394. If a server 138 has initiated a request base unit 130 interprets the request in a step 3344 and acts upon the request and generates a response in a step 3354. Upon completion of the server response generation base unit 130 transmits a response associated with a server 138 request 3284. If server 138 has not initiated a request as determined in a step 3394 the mobile unit 110 re-executes a test to determine if a mobile unit transmission has been received in step 3234 and the process reiterates until the acknowledgement of step 3264 is performed.

The receiver of circuit 134 listens in step 3234 for any transmissions from broadcast circuit 111, recovers the information, conveys the information to the CPU of circuit 134 where additional processing of the information is performed in a step 3244, and stores the processed information in local memory along with a time stamp for the received time for the reception. The information processing filters the received data using digital filtering methods thereby reducing the error content present in the data and enhancing position determination. If base unit 130 determines that a transmission has been received from a mobile unit 110 in step 3234 the received data is processed and the data is validated to insure integrity in step 3244. During the processing of the information, CPU 134 examines the content of the data and determines whether an error-free transmission from the broadcast circuit was received in a step 3254. If an error-free transmission from broadcast circuit 111 was received the CPU 134 directs the transceiver to transmit an acknowledgement signal in a step 3264.

Base unit 130 subsequently executes a test to determine if the received data from mobile unit 110 contains errors in step 3254. If errors are found in step 3254, the errors are logged into the memory associated with circuit 134 in a step 3274, and the execution returns to re-enabling the receiver in steps 3223-3243. If no errors are found in step 3254 base unit 130 executes a test in a step 3364 to determine if the Retry Timer is enabled. If the Retry Timer is enabled the process returns to step 3253 to ascertain if the Retry Timer has reached the timeout condition. If the Retry Timer is not enabled as determined in step 3364 base unit 130 transmits an acknowledge signal to mobile unit 110 in step 3264. Upon completion of the acknowledgement signal in step 3264 base unit 130 transmits the requested information to server 138 in a step 3284.

in step 3284 the base unit 130 will transmit the processed information stored in local memory to the server 138 over any of the available physical media, which can include but are not limited to wire line, wireless, or optical media. After the transmission of the information to server 138 base unit 130 executes a test to determine if it has received an acknowledgement signal from server 138 in a step 3294 confirming receipt of the information.

If a server acknowledgement signal is received in step 3294 the retry timer is disabled in a step 3374 to disable additional server communication retries, and the retry counter value is cleared. The process then resumes in step 3243 to determine the state of the Retry Timer. If a server acknowledgement signal is not received in step 3294 the Retry Counter of circuit 134 is incremented in a step 3384. This is followed by the execution of a test to determine whether the Retry Counter has exceeded a threshold value in a step 3394. If the threshold value of the Retry Counter is not exceeded as determined by base station 130 in step 3394 a retransmission is attempted by returning the process to step 3284. If the threshold value of the Retry Counter is exceeded as determined in step 3394 the event is logged into the error log in a step 3314, the Retry Timer is enabled and execution returns to step 3243 to test the state of the Retry Timer.

In a preferred but non limiting embodiment, server 138 as depicted in FIG. 5, operates on a computer readable medium having computer readable program code embodied therein. The computer readable medium consists of computer readable program code configured to receive, at server 138, location information associated with the mobile device 130 from at least one detection circuit 129 located in a base unit 130 associated with mobile unit 110.

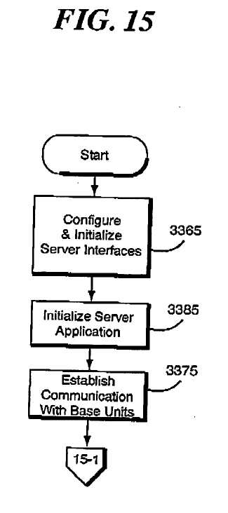

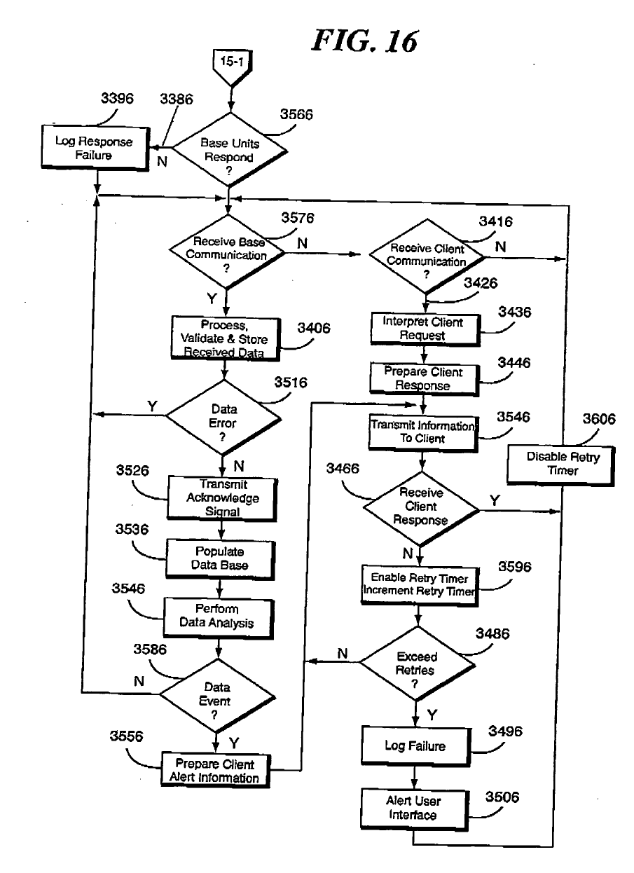

Reference is now made to FIGS. 15 and 16 wherein the operation of servers 138, 152 in accordance with instructions stored on the computer readable program code is provided. The processing is initiated by configuring and initializing the server interfaces in a step 3365. Upon completion of the initialization tasks, server 152 (by way of non limiting example) initializes the server application in accordance with computer readable program code in a step 3385. At the completion of the server application initialization, server 152 attempts to establish the communication link with the mobile units 1531-N in a step 3375. The server then executes a test in a step 3566 to determine if responses have been received from base units 153 1-N. If server 152 cannot establish communication in a step 3385 with any base unit 153 server 152 stores the response failure in a step 3396 in the failure log and continues operation.

Server 152 next executes a test in a step 3576 to determine if any base unit 153 has attempted to establish communications with server 152. If server 152 has received a communication from a base unit 153, the server 152 will process, validate, and store the received information in a step 3406. Server 152 next executes a test to determine if there were any data errors in the data received from base unit 153 in a step 3516. If data errors are present server 152 does not acknowledge the transmission and returns to listen for incoming communication from the base unit 153 in a step 3576. If no data errors are received from the base unit server 152 transmits an acknowledgement signal to base unit 130 in a step 3526. After completion of the acknowledgement server 152 populates the received data into a server application database in a step 3536.

Upon completion of the data base activities in step 3536, server 152 analyzes the newly received information and processes this data with previously received information to enable data analysis in a step 3546. Upon completion of the data analysis in step 3546, server 152 compares the analyzed data with thresholds to determine whether an event requiring action has occurred in a step 3586. If a data event has not occurred the server returns to listen for base communications 3576. If a data event has occurred the server prepares alert information in a step 3556. The server then transmits the alert information to the client in a step 3456. After the transmission is completed the server listens for an acknowledgement response from the client in a step 3466. If an acknowledgement response is received execution proceeds to a step 3606 to disable the retry timer and the process returns to step 3576 to listen for any communications from base units 153 1-N. If an acknowledgement is not received from the client in step 3476, server 152 enables the retry timer and increments the count of the retry timer in a step 3596.

Server 152 proceeds to execute a test to compare the retry timer to a threshold value in a step 3486 to determine if the number of communication retries to the client have exceeded a threshold. If the number of retries are less than the threshold the server attempts to retransmit the alert information to the client in step 3456. If the number of retries have met and/or exceeded the threshold the server logs the failure in a step 3496, generates an alert at the user interface of the server 152 in a step 3506, then proceeds to disable the retry timer in a step 3606, followed by listening for communications from base unit 3576.

Users can remotely query the server 152 in a step 3416 and receive information for the mobile units 153-1-N that are stored and updated in the database in a step 3536. The user queries can utilize standard Graphical User Interfaces (GUIs) such as Internet browsers, utilize secure logins with password protection, and is capable of protecting all data transferred to and from the GUIs utilizing encryption and authentication for user security and privacy.

The user query initiates the process by generating a client communication received at server 152 in a step 3426 whereupon server 152 interprets the client request in a step 3436. Upon interpretation of the client request server 152 extracts the necessary information from the database and prepares a client response in a step 3446. The information requested by the client will be transmitted in a step 3456 to the client in response to the request. Upon completion of the transmission to the client server 152 will listen in a step 3466 for an acknowledgement response from the client. If an acknowledgement is not received server 152 enables the retry timer and increments the count of the retry timer in a step 3596. Server 152 executes a test to compare the retry timer to a threshold value in a step 3486 to determine if the number of communication retries to the client have exceeded the threshold. If the number of retries are less than the threshold server 152 attempts to retransmit the alert information to the client in a step 3456. If the number of retries have met and/or exceeded the threshold server 152 logs the failure in a step 3496, generates an alert at the user interface of server 152 in a step 3506, then proceeds to disable the Retry Timer in a step 3606 in a step, followed by listening for communications from the base unit 130 in step 3576.

By utilizing mobile units in accordance with the invention, there is no duty cycle limitation tied to the life of the battery, because the asset tracking device does not exit the low power quiescent state and increase power consumption until the asset exceeds a predetermined motion threshold.

In addition the asset tracking device can be set to a preprogrammed threshold to enable the device to remain in the quiescent state until the asset experiences a preprogrammed acceleration threshold, due to a fall or a substantial and/or damaging impact, thereby alerting the user to the occurrence of the asset experiencing a catastrophic event.

By providing a motion sensor trigger as part of the broadcast circuit, mobile devices associated with the asset not experiencing motion above a predetermined value, yields power experiences with minimal power drain.

By utilizing information regarding the acceleration, velocity, and physical displacement of the mobile device in three orthogonal directions, a more accurate location resolution is provided.

By providing a broadcast circuit capable of providing information regarding the acceleration of the mobile device in three orthogonal directions, it provides the user the ability to be alerted to accelerations above a predetermined threshold, which can signify the mobile device experiencing rapid acceleration, as in a fall or a significant impact of the mobile device.

By fusing the motion information from the mobile device with received signal parameters such as direction of arrival, signal phase, and signal strength at the detection circuit, the accuracy of the mobile device location estimate is increased.

Because the broadcast circuit is capable of providing information regarding the acceleration, velocity, and physical displacement of the mobile device in three orthogonal directions, combined with the received signal parameters at the detection circuit it provides the user the ability to be alerted to the mobile device departing from a predetermined region surrounding the detection circuit.

By utilizing the broadcast system as discussed above information regarding the state of charge of the battery is provided when the mobile device exits the quiescent condition due to experiencing motion above a predetermined value, or periodically when the battery level in the broadcast system reaches a predetermined level.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

What is claimed as new and desired to be protected by Letters Patent of the United States is:

1. A low power asset tracking system comprising:
a mobile unit adapted to be associated with an asset to be tracked, the mobile unit including a broadcast circuit, the broadcast circuit comprising:
a motion sensor for determining motion of the mobile unit in at least one direction,
a transceiver receiving a motion information signal as a function of an output of said motion sensor;
a power source for powering said motion sensor and transceiver;
an energizing circuit operatively disposed between said power source and transceiver for selectively powering said transceiver;
said energizing circuit selectively energizing said transceiver in response to an output of an energizing signal from said motion sensor, the motion sensor providing an energizing signal to said energizing circuit upon detection of a motion in at least one direction of the mobile unit in excess of a threshold amount.

2. The system of claim 1, wherein said motion sensor is an accelerometer.

3. The system of claim 1, wherein said motion sensor outputs said energizing signal as a function of at least one of acceleration, distance, velocity, speed and time.

4. The system of claim 1, wherein the mobile unit further comprises a CPU, the CPU being powered by said power source, said energizing circuit being disposed between said power source and said CPU to selectively energize the CPU, the CPU receiving data from at least said motion sensor and providing a data output to said transceiver corresponding to a motion of said mobile unit.

5. The system of claim 4, further comprising an alert circuit, said alert circuit being operatively coupled to said CPU, said CPU causing said alert circuit to indicate an alert, when said data input from said motion sensor indicates motion above a threshold amount.

6. The system of claim 1, further comprising a base unit;
the base unit including a detection circuit; said detection circuit including a detection transceiver in communication with said broadcast circuit for receiving the motion information.

7. The system of claim 6, wherein said detection circuit further comprises a detection CPU; said detection CPU receiving an input from said transceiver of the motion information signal; and a media interface in communication with the CPU.

8. The system of claim 6, wherein the detection CPU determines a new location for the asset as a function of the motion information.

9. The system of claim 5 further comprising a server;
said server in communication with said base unit across a communication link to said media interface.

10. The system of claim 5, wherein CPU transmits the motion information to the server, and the server determines a new location for the asset as a function of the motion information.

11. The system of claim 10, further comprising a client device; a communication link between the client device and the server, the server providing asset information to the client device across the communication link.

12. The system of claim 9, wherein the communication link is the cloud.

13. The system of claim 1, further comprising a second mobile unit adapted to be associated with a second asset to be tracked, the mobile unit including a second broadcast circuit for communicating with the broadcast circuit of another mobile unit.

14. The system of claim 6, further comprising a second mobile unit adapted to be associated with a second asset to be tracked, the mobile unit including a second broadcast circuit for communicating with the broadcast circuit of another mobile unit.

15. A mobile unit for a low power asset tracking system comprising:
a motion sensor for determining motion of the mobile unit in at least one direction;
a transceiver receiving a motion information signal as a function of an output of said motion sensor;
a power source for powering said motion sensor and transceiver;
an energizing circuit operatively disposed between said power source and transceiver for selectively powering said transceiver;
said energizer circuit selectively energizing said transceiver in response to an output of an energizing signal from said motion sensor, the motion sensor providing the energizing signal to said energizing circuit upon detection of a motion of the mobile unit in excess of a threshold amount in at least one direction.

16. The mobile unit of claim 15, wherein said motion sensor is an accelerometer.

17. The system of claim 15, wherein the motion sensor is a gyroscope.

18. The mobile unit of claim 15, wherein said motion sensor outputs the energizing signal as a function of at least one of acceleration, distance, velocity, speed and time.

19. The mobile unit of claim 15, further comprising a CPU, the CPU being powered by said power source, said energizing circuit being disposed between said power source and said CPU to selectively energize the CPU, the CPU receiving data from at least said motion sensor and providing a motion information output to said transceiver corresponding to a motion of said mobile unit.

20. The mobile unit of claim 15, further comprising an alert circuit, said alert circuit being operatively coupled to said CPU, said CPU causing said alert circuit to indicate an alert from said data input from said motion sensor indicates motion above a threshold amount.
